(19) United States
(12) Patent Application Publication
(10) Pub. No.: US 2017/0019683 A1
(43) Pub. Date: Jan. 19, 2017

(54) VIDEO ENCODING APPARATUS AND METHOD AND VIDEO DECODING APPARATUS AND METHOD

(71) Applicant: NIPPON TELEGRAPH AND TELEPHONE CORPORATION, Tokyo (JP)

(72) Inventors: Shinya SHIMIZU, Yokosuka-shi (JP); Shiori SUGIMOTO, Yokosuka-shi (JP)

(73) Assignee: NIPPON TELEGRAPH AND TELEPHONE CORPORATION, Tokyo (JP)

(21) Appl. No.: 15/125,828

(22) PCT Filed: Mar. 12, 2015
(86) PCT No.: PCT/JP2015/057254

§ 371 Date: Sep. 13, 2016

(30) Foreign Application Priority Data
Mar. 20, 2014 (JP) 2014-058903

(51) Int. Cl. H04N 19/597; H04N 19/513; H04N 19/573

(52) U.S. Cl. CPC H04N 19/597; H04N 19/573; H04N 19/513; H04N 19/172

(57) ABSTRACT

When one frame of multiview videos is encoded, each of encoding target regions obtained by dividing an encoding target image is encoded while motion information for a reference viewpoint image from a reference viewpoint other than a viewpoint of the encoding target image is used to perform prediction between different viewpoints. According to information, which indicates a corresponding region on the reference viewpoint image for the encoding target region, and the motion information for the reference viewpoint image, temporary motion information for the corresponding region is determined. Disparity information assigned to a region from the reference viewpoint, which is indicated by the temporary motion information, with respect to the viewpoint of the encoding target image, and the information which indicates the corresponding region are utilized to perform transformation of the temporary motion information, so as to generate motion information for the encoding target region.

### TECHNICAL FIELD

The present invention relates to a video encoding apparatus, a video decoding apparatus, a video encoding method, and a video decoding method, which are utilized to encode and decode multiview videos.

Priority is claimed on Japanese Patent Application No. 2014-058903, filed Mar. 20, 2014, the contents of which are incorporated herein by reference.

### BACKGROUND ART

Conventionally, multiview images are known, which are formed by a plurality of images obtained by a plurality of cameras, where the same object and background thereof are imaged by the cameras. Video images obtained by a plurality of cameras is called “multiview (or multi-viewpoint) video images” (or “multiview videos”).

In the following explanation, an image (or video) obtained by one camera is called a “two-dimensional image (or two-dimensional video)”, and a set of two-dimensional images (or two-dimensional videos) in which the same object and background thereof are photographed by a plurality of cameras having different positions and directions (where the position and direction of each camera is called a “viewpoint” below) is called “multiview images (or multiview videos)”.

There is a strong temporal correlation in the two-dimensional video and the level of encoding efficiency therefor can be improved by utilizing this correlation. For the multiview images (or video), when the individual cameras are synchronized with each other, the frames (images) corresponding to the same time in the videos obtained by the individual cameras capture the object and background thereof in entirely the same state from different positions, so that there is a strong correlation between the cameras (i.e., between different two-dimensional images obtained at the same time). The level of encoding efficiency for the multiview images or videos can be improved using this correlation.

Here, conventional techniques relating to the encoding of a two-dimensional video will be shown. In many known methods of encoding a two-dimensional video, such as H.264, MPEG-2, MPEG-4 (which are international encoding standards), and the like, highly efficient encoding is performed by means of motion-compensated prediction, orthogonal transformation, quantization, entropy encoding, or the like. For example, in H.264, it is possible to perform encoding using temporal correlation between an encoding target frame and a plurality of past or future frames.

For example, Non-Patent Document 1 discloses detailed motion compensation prediction techniques used in H.264. Below, general explanations of the motion compensation prediction techniques used in H.264 will be shown.

In the motion compensation used in H.264, an encoding target frame is divided into blocks of any size, and each block can have an individual motion vector and an individual reference frame. When each block uses an individual motion vector, highly accurate prediction is implemented by compensating a specific motion of each object. In addition, when each block uses an individual reference frame, highly accurate prediction is also implemented in consideration of occlusion generated according to a temporal change.

Next, conventional encoding methods for multiview images or multiview videos will be explained.

In comparison with the encoding method for multiview image, in the encoding method for multiview videos, there simultaneously exists a temporal correlation in addition to the correlation between the cameras. However, in either case, the inter-camera correlation can be utilized by an identical method. Therefore, a method applied to the encoding of multiview videos will be explained below.

Since the encoding of multiview videos utilizes the inter-camera correlation, a known method highly efficiently encodes multiview videos by means of “disparity-compensated prediction” which applies motion-compensated prediction to images obtained at the same time by different cameras. Here, disparity is the difference between positions at which an identical part on an object exists on the image planes of cameras which are disposed at different positions.

FIG. 8 is a schematic view showing the concept of disparity generated between cameras (here, “camera 1” and “camera 2”). The schematic view of FIG. 8 shows a state in which an observer looks down on image planes of cameras, whose optical axes are parallel to each other, from the upper side thereof Generally, positions to which an identical point on an object is projected, on image planes of different cameras, are called “corresponding points”.

In the disparity-compensated prediction, based on the above corresponding relationship, each pixel value of an encoding target frame is predicted using a reference frame, and the relevant prediction residual and disparity information which indicates the corresponding relationship are encoded. Since disparity varies for a target pair of cameras or relevant positions, it is necessary to encode the disparity information for each region to which the disparity-compensated prediction is applied.

In a multiview video encoding method defined in H.264, a vector which represents the disparity information is encoded for each block to which the disparity-compensated prediction is applied.

Here, by using camera parameters and the Epipolar geometry constraint, the above corresponding relationship obtained by the disparity information may be represented by a one-dimensional quantity which represents a three-dimensional position of an object, without using a two-dimensional vector.

Although the information which represents the three-dimensional position of an object may be represented in various manners, the distance from a camera (as a standard) to the object or coordinate values on an axis which is not parallel to the image plane of the camera is employed generally. Here, instead of the distance, a reciprocal thereof may be employed. In addition, since the reciprocal of the distance functions as information in proportion to disparity, two cameras may be prepared as standards, and the amount of disparity between images obtained by these cameras may be employed as the relevant representation.

There is no substantial difference between such representations. Therefore, the representations will not be distinguished with each other below and the information which represents the three-dimensional position is generally called a “depth”.

Multiview videos have the inter-camera correlation, not only for the image signal, but also for motion information. Non-Patent Document 2 utilizes such a correlation, where motion information for an encoding target frame is estimated from a reference frame based on a corresponding relationship obtained by disparity (“interview motion vector prediction”), and thereby the amount of code required for the encoding of the motion information is reduced and efficient encoding of multiview videos is implemented.

### PRIOR ART DOCUMENT

### Non-Patent Document

Non-Patent Document 1: ITU-T Recommendation H.264 (March 2009), “Advanced video coding for generic audiovisual services”, March 2009.

Non-Patent Document 2: J. Konieczny and M. Domanski, “Depth-based interview prediction of motion vectors for improved multiview video coding,” in Proc. 3DTV-CON2010, June 2010.

### DISCLOSURE OF INVENTION

### Problem to be Solved by the Invention

In the method of Non-Patent Document 2, motion information for a reference frame is determined to be motion information for an encoding target frame based on a corresponding relationship obtained by disparity. Therefore, if the motion information for the reference frame does not coincide with actual motion information for the encoding target frame, the target image signal is predicted by using erroneous motion information and thus the amount of code required to encode the prediction residual for the image signal increases.

In a method to solve the above problem, the motion information for the reference frame is not copied but used as prediction motion information to perform predictive encoding of the motion information for the encoding target frame, which prevents an increase in the amount of code required to encode the prediction residual for the image signal and makes it possible to perform the encoding which uses a correlation for inter-camera motion information.

Generally, the motion of an object is a free motion performed in a three-dimensional space. Therefore, a motion observed by a specific camera is a result of projection of such a three-dimensional motion onto a two-dimensional plane which is a projection plane of the camera.

When a three-dimensional motion is projected onto projection planes of two different cameras, corresponding motion information items coincide with each other only when the two cameras are arranged in parallel and the three-dimensional motion is performed on a plane perpendicular to the optical axes of the cameras. That is, when such a specific condition is not satisfied, the inter-camera correlation for the motion information between frames from different viewpoints is low. Therefore, even if the motion information generated by the method disclosed in Non-Patent Document 2 is used in prediction, it is impossible to highly accurately predict target motion information and thus reduce the amount of code required to encode the motion information.

In light of the above circumstances, an object of the present invention is to provide a video encoding apparatus, a video decoding apparatus, a video encoding method, and a video decoding method, by which even when the inter-camera correlation for motion information between frames from different viewpoints is low, highly accurate prediction for the motion information is implemented, and thus highly efficiently encoding can be performed.

### Means for Solving the Problem

The present invention provides a video encoding apparatus that encodes one frame of multiview videos from different viewpoints, where each of encoding target regions obtained by dividing an encoding target image is encoded while reference viewpoint motion information, which is motion information for a reference viewpoint image from a reference viewpoint other than a viewpoint of the encoding target image, is used to perform prediction between different viewpoints, the apparatus comprising:

an encoding target region disparity information determination device that determines, for the encoding target region, encoding target region disparity information which indicates a corresponding region on the reference viewpoint image;

a temporary motion information determination device that determines, from the reference viewpoint motion information, temporary motion information for the corresponding region on the reference viewpoint image, which is indicated by the encoding target region disparity information;

a past disparity information determination device that determines past disparity information which is disparity information assigned to a region from the reference viewpoint, which is indicated by the temporary motion information, with respect to the viewpoint of the encoding target image; and

a motion information generation device that generates motion information for the encoding target region by performing transformation of the temporary motion information by using the encoding target region disparity information and the past disparity information.

In a typical example, the motion information generation device generates the motion information for the encoding target region by:

restoring motion information of an object in a three-dimensional space from the temporary motion information by using the encoding target region disparity information and the past disparity information; and

projecting the restored motion information onto the encoding target image.

In another typical example, the apparatus further comprises:

a reference target region dividing device that divides the corresponding region on the reference image into smaller regions,

wherein the temporary motion information determination device determines the temporary motion information for each smaller region; and

the motion information generation device generates the motion information for each smaller region.

In this case, the past disparity information determination device may determine the past disparity information for each smaller region.

In a preferable example, the encoding target region disparity information determination device determines the encoding target region disparity information from a depth map for an object imaged in the multiview videos.

In another preferable example, the past disparity information determination device determines the past disparity information from a depth map for an object imaged in the multiview videos.

In another preferable example, the apparatus further comprises:

a present disparity information determination device that determines present disparity information which is disparity information assigned to the corresponding region on the reference image with respect to the viewpoint of the encoding target image,

wherein the motion information generation device performs the transformation of the temporary motion information by using the present disparity information and the past disparity information.

The present disparity information determination device may determine the present disparity information from a depth map for an object imaged in the multiview videos.

Furthermore, the motion information generation device may generate the motion information for the encoding target region by using the sum of the encoding target disparity information, the past disparity information, and the temporary motion information.

The present invention also provides a video decoding apparatus that decodes a decoding target image from encoded data of multiview videos from different viewpoints, where each of decoding target regions obtained by dividing a decoding target image is decoded while reference viewpoint motion information, which is motion information for a reference viewpoint image from a reference viewpoint other than a viewpoint of the decoding target image, is used to perform prediction between different viewpoints, the apparatus comprising:

a decoding target region disparity information determination device that determines, for the decoding target region, decoding target region disparity information which indicates a corresponding region on the reference viewpoint image;

a temporary motion information determination device that determines, from the reference viewpoint motion information, temporary motion information for the corresponding region on the reference viewpoint image, which is indicated by the decoding target region disparity information;

a past disparity information determination device that determines past disparity information which is disparity information assigned to a region from the reference viewpoint, which is indicated by the temporary motion information, with respect to the viewpoint of the decoding target image; and

a motion information generation device that generates motion information for the decoding target region by performing transformation of the temporary motion information by using the decoding target region disparity information and the past disparity information.

In a typical example, the motion information generation device generates the motion information for the decoding target region by:

restoring motion information of an object in a three-dimensional space from the temporary motion information by using the decoding target region disparity information and the past disparity information; and

projecting the restored motion information onto the decoding target image.

In another typical example, the apparatus further comprises:

a reference target region dividing device that divides the corresponding region on the reference image into smaller regions,

wherein the temporary motion information determination device determines the temporary motion information for each smaller region; and

the motion information generation device generates the motion information for each smaller region.

In this case, the past disparity information determination device may determine the past disparity information for each smaller region.

In a preferable example, the decoding target region disparity information determination device determines the decoding target region disparity information from a depth map for an object imaged in the multiview videos.

In another preferable example, the past disparity information determination device determines the past disparity information from a depth map for an object imaged in the multiview videos.

In another preferable example, the apparatus further comprises:

a present disparity information determination device that determines present disparity information which is disparity information assigned to the corresponding region on the reference image with respect to the viewpoint of the decoding target image,

wherein the motion information generation device performs the transformation of the temporary motion information by using the present disparity information and the past disparity information.

The present disparity information determination device may determine the present disparity information from a depth map for an object imaged in the multiview videos.

Furthermore, the motion information generation device may generate the motion information for the decoding target region by using the sum of the decoding target disparity information, the past disparity information, and the temporary motion information.

The present invention also provides a video encoding method that encodes one frame of multiview videos from different viewpoints, where each of encoding target regions obtained by dividing an encoding target image is encoded while reference viewpoint motion information, which is motion information for a reference viewpoint image from a reference viewpoint other than a viewpoint of the encoding target image, is used to perform prediction between different viewpoints, the method comprising:

an encoding target region disparity information determination step that determines, for the encoding target region, encoding target region disparity information which indicates a corresponding region on the reference viewpoint image;

a temporary motion information determination step that determines, from the reference viewpoint motion information, temporary motion information for the corresponding region on the reference viewpoint image, which is indicated by the encoding target region disparity information;

a past disparity information determination step that determines past disparity information which is disparity information assigned to a region from the reference viewpoint, which is indicated by the temporary motion information, with respect to the viewpoint of the encoding target image; and

a motion information generation step that generates motion information for the encoding target region by performing transformation of the temporary motion information by using the encoding target region disparity information and the past disparity information.

The present invention also provides a video decoding method that decodes a decoding target image from encoded data of multiview videos from different viewpoints, where each of decoding target regions obtained by dividing a decoding target image is decoded while reference viewpoint motion information, which is motion information for a reference viewpoint image from a reference viewpoint other than a viewpoint of the decoding target image, is used to perform prediction between different viewpoints, the method comprising:

a decoding target region disparity information determination step that determines, for the decoding target region, decoding target region disparity information which indicates a corresponding region on the reference viewpoint image;

a temporary motion information determination step that determines, from the reference viewpoint motion information, temporary motion information for the corresponding region on the reference viewpoint image, which is indicated by the decoding target region disparity information;

a past disparity information determination step that determines past disparity information which is disparity information assigned to a region from the reference viewpoint, which is indicated by the temporary motion information, with respect to the viewpoint of the decoding target image; and

a motion information generation step that generates motion information for the decoding target region by performing transformation of the temporary motion information by using the decoding target region disparity information and the past disparity information.

### Effect of the Invention

According to the present invention, even when the inter-viewpoint correlation for motion information is low, highly accurate prediction for the motion information can be implemented by utilizing transformation according to a three-dimensional motion of an object, and thus multiview videos can be encoded with less amount of code.

### BRIEF DESCRIPTION OF THE DRAWINGS

FIG. 1 is a block diagram that shows the structure of the video encoding apparatus according to an embodiment of the present invention.

FIG. 2 is a flowchart showing the operation of the video encoding apparatus 100 shown in FIG. 1.

FIG. 3 is a flowchart that shows a detailed motion information generation operation (step S103) by the motion information generation unit 106 shown in FIG. 1.

FIG. 4 is a block diagram that shows the structure of the video decoding apparatus according to an embodiment of the present invention.

FIG. 5 is a flowchart showing the operation of the video decoding apparatus 200 shown in FIG. 4.

FIG. 6 is a block diagram that shows a hardware configuration of the video encoding apparatus 100 (in FIG. 1) formed using a computer and a software program.

FIG. 7 is a block diagram that shows a hardware configuration of the video decoding apparatus 200 (in FIG. 4) formed using a computer and a software program.

FIG. 8 is a schematic view showing the concept of disparity generated between cameras.

### MODE FOR CARRYING OUT THE INVENTION

Below, a video encoding apparatus and a video decoding apparatus as embodiments of the present invention will be explained with reference to the drawings.

The following explanation asserts that multiview videos obtained from two viewpoints, which are a first viewpoint (called “viewpoint A”) and a second viewpoint (called “viewpoint B”), are encoded, where one frame of the video from the viewpoint B is encoded or decoded by utilizing the viewpoint A as a reference viewpoint.

Here, it is assumed that information required to obtain disparity from depth information is provided separately as needed. Specifically, such information may be an external parameter that represents a positional relationship between the viewpoints A and B, or an internal parameter that represents information for projection by a camera onto an image plane. However, information other than the above may be employed if required disparity can be obtained from the relevant depth information by using the employed information.

A detailed explanation about such camera parameters is found, for example, in the following reference document: Oliver Faugeras, “Three-Dimension Computer Vision”, MIT Press; BCTC/UFF-006.37 F259 1993, ISBN:0-262-06158-9. This reference document explains a parameter which indicates a positional relationship between a plurality of cameras, and a parameter which indicates information for the projection by a camera onto an image plane.

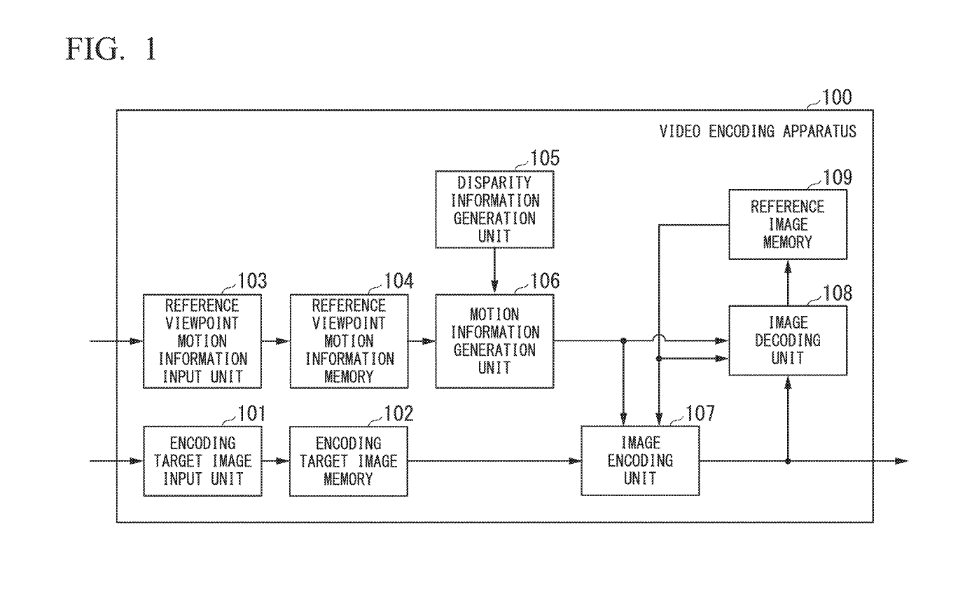

FIG. 1 is a block diagram that shows the structure of the video encoding apparatus according to the present embodiment.

As shown in FIG. 1, the video encoding apparatus 100 has an encoding target image input unit 101, an encoding target image memory 102, a reference viewpoint motion information input unit 103, a reference viewpoint motion information memory 104, a disparity information generation unit 105, a motion information generation unit 106, an image encoding unit 107, an image decoding unit 108, and a reference image memory 109.

The encoding target image input unit 101 inputs an image as an encoding target into the video encoding apparatus 100. Below, this image as the encoding target is called an “encoding target image”. Here, a video from the viewpoint B is input, frame by frame, in encoding order determined separately. In addition, the viewpoint (here, the viewpoint B) from which the encoding target image is obtained is called an “encoding target viewpoint”.

The encoding target image memory 102 stores the input encoding target image.

The reference viewpoint motion information input unit 103 inputs motion information (e.g., motion vector) for a video from the reference viewpoint (here, the viewpoint A) into the video encoding apparatus 100. Below, the motion information input here is called “reference viewpoint motion information”, and a frame (at the same time as that of the encoding target image) to which the reference viewpoint motion information is assigned is called a “reference viewpoint image”.

The reference viewpoint motion information memory 104 stores the input reference viewpoint motion information.

If the encoding target image or reference viewpoint motion information is stored outside the video encoding apparatus 100 and the encoding target image input unit 101 or the reference viewpoint motion information input unit 103 inputs the required encoding target image or reference viewpoint motion information into the video encoding apparatus 100 at appropriate timing, it is unnecessary to provide the encoding target image memory 102 or the reference viewpoint motion information memory 104.

The disparity information generation unit 105 generates disparity information (disparity vector) between the encoding target image and the reference viewpoint image.

The motion information generation unit 106 generates motion information of the encoding target image by using the reference viewpoint motion information and the disparity information.

The image encoding unit 107 performs predictive encoding of the encoding target image by using the generated motion information.

The image decoding unit 108 decodes a bit stream of the encoding target image.

The reference image memory 109 stores a decoded image obtained when the bit stream of the encoding target image is decoded.

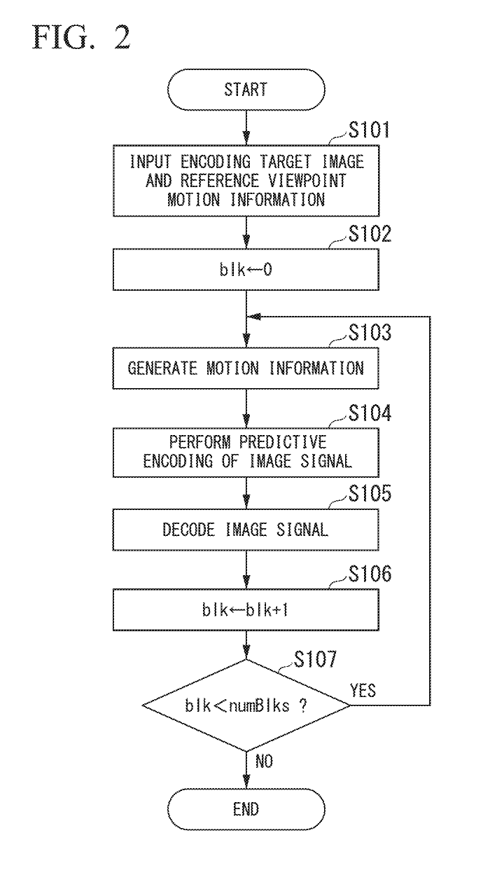

Next, the operation of the video encoding apparatus 100 shown in FIG. 1 will be explained with reference to FIG. 2. FIG. 2 is a flowchart showing the operation of the video encoding apparatus 100 shown in FIG. 1.

First, the encoding target image input unit 101 inputs an encoding target image into the video encoding apparatus 100 and stores the input image in the encoding target image memory 102. The reference viewpoint motion information input unit 103 inputs reference viewpoint motion information into the video encoding apparatus 100 and stores the input information in the reference viewpoint motion information memory 104 (see step S101).

Here, the reference viewpoint motion information input in step S101 is identical to that (which may be decoded information of already-encoded information) obtained in a corresponding decoding apparatus. This is because generation of encoding noise (e.g., drift) can be suppressed by using the completely same information as information which can be obtained in the decoding apparatus. However, if generation of such encoding noise is acceptable, information which can be obtained only in the encoding apparatus may be input (e.g., information which has not yet been encoded).

The reference viewpoint motion information may be (i) motion information which was used when the reference viewpoint image was encoded or (ii) motion information which was encoded separately for the reference viewpoint. In addition, a video from the reference viewpoint may be decoded and motion information estimated from the decoded video may be utilized.

After the input of the encoding target image and the reference viewpoint motion information is completed, the encoding target image is divided into regions having a predetermined size and encoding of the image signal of the encoding target image is performed for each divided region (see steps S102 to S107).

More specifically, given “blk” for an encoding target region index and “numBlks” for the total number of encoding target regions in one frame, blk is initialized to be 0 (see step S102), and then the following process (from step S103 to step S105) is repeated while adding 1 to blk each time (see step S106) until blk reaches numBlks (see step S107).

In ordinary encoding, the encoding target image is divided into processing unit blocks called “macroblocks” each being formed as 16×16 pixels. However, it may be divided into blocks having another block size if the condition is the same as that in the decoding apparatus. In addition, the divided regions may have individual sizes.

In the process repeated for each encoding target region, first, the motion information generation unit 106 generates motion information “mv” for the encoding target region blk (see step S103). This process will be explained later in detail.

After the motion information for the encoding target region blk is obtained, the image encoding unit 107 performs predictive encoding of the image signal (i.e., pixel values) for the encoding target region blk by using the motion information my and also referring to an image stored in the reference image memory 109 (see step S104). A bit stream obtained by this encoding is a signal output from the video encoding apparatus 100.

The above encoding may be performed by any method. In generally known encoding such as MPEG-2 or H.264/AVC, a difference signal between the image signal of the block blk and predicted image therefor is sequentially subjected to frequency transformation such as DCT, quantization, binarization, and entropy encoding.

How to use the generated motion information my in the encoding is not limited. For example, the image signal of the encoding target region blk may be encoded for a predicted image which is a motion compensation predicted image by using the motion information my.

In another method, a correction vector “cmv” for the above “mv” is determined and encoded, and motion information is obtained by correcting my by cmv. A motion compensation predicted image generated according to the corrected motion information is used as the predicted image to encode the image signal of the encoding target region blk. In this case, a bit stream for cmv is also output.

Next, the image decoding unit 108 decodes the image signal of the block blk by using the bit stream, the motion information my, and an image stored in the reference image memory 109. The image decoding unit 108 stores a decoded image as the decoding result in the reference image memory 109 (see step S105).

Here, a method corresponding to the method utilized in the encoding is used. For example, for generally known encoding such as MPEG-2 or H.264/AVC, the relevant bit stream is sequentially subjected to entropy decoding, inverse binarization, inverse quantization, and frequency inverse transformation such as IDCT. An obtained two-dimensional signal is added to the predicted image and clipping within the value range of the pixels is finally performed so as to decode the relevant image signal.

In addition, the decoding process may be performed in a simplified decoding manner by receiving relevant data and predicted image immediately before the process in the encoding apparatus becomes lossless. That is, in the above-described example, the relevant image signal may be decoded by (i) receiving a value after performing the quantization and the predicted image in the encoding, (ii) sequentially applying the inverse quantization and the frequency inverse transformation to the quantized value to obtain a two-dimensional signal to which the predicted image is added, and (iii) performing the clipping within the value range of the pixels.

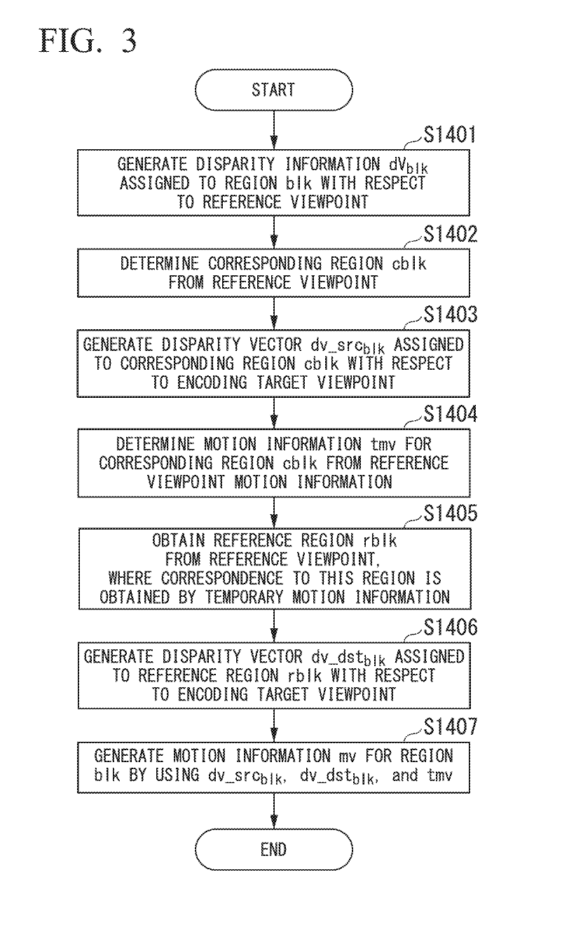

Next, with reference to FIG. 3, the process of generating motion information for the encoding target region blk (performed in step S103 of FIG. 2 by the motion information generation unit 106 in FIG. 1) will be explained in detail. FIG. 3 is a flowchart that shows the relevant generation process.

In the process of generating the motion information, first, the disparity information generation unit 105 determines a disparity vector dV_{blk} (corresponding to the encoding target region disparity information of the present invention) assigned to the encoding target region blk with respect to the reference viewpoint image (see step S1401).

Any method can be applied to the above process if the same process can be performed in a corresponding decoding apparatus.

For example, the following disparity vector may be employed: a disparity vector used when a peripheral region of the encoding target region blk was encoded, a global disparity vector assigned to the entire encoding target image or a partial image which includes the encoding target region, or a disparity vector which is determined and encoded separately for the encoding target region. In addition, a disparity vector which was used for another region or for a previously-encoded image may be stored and used.

Additionally, a plurality of disparity vector candidates may be determined and an average vector thereof may be used, or one disparity vector among them may be selected according to a certain criterion (most frequent value, median, maximum norm, minimum norm, or the like) to determine the target disparity vector.

If a target of a stored disparity vector is from a viewpoint other than the reference viewpoint, transformation may be performed by means of scaling according to a positional relationship between this other viewpoint and the reference viewpoint.

In another method, a depth map for the encoding target image is input into the video encoding apparatus separately, and disparity information for the reference viewpoint image may be determined based on a depth map at the same location as that for the encoding target region blk.

In another method, when one of viewpoints other than the encoding target viewpoint is determined to be a depth viewpoint, a depth map corresponding to the depth viewpoint is input into the relevant apparatus separately, and the target disparity information may be determined by using this depth map.

More specifically, disparity DV between the encoding target viewpoint and the depth viewpoint for the encoding target region blk is estimated, and the disparity information for the reference viewpoint image may be determined based on a depth map at a position defined by “blk+DV”.

Next, a corresponding region “cblk” from the reference viewpoint is determined according to a correspondence obtained by the disparity information dV_{blk} (see step S1402). Specifically, cblk is obtained by adding the generated disparity information dV_{blk} to blk. Here, the corresponding region cblk belongs to the reference viewpoint image and is indicated by the disparity information dV_{blk}.

After the corresponding region cblk is obtained, the disparity information generation unit 105 determines a disparity vector dv_src_{blk} (corresponding to the present disparity information of the present invention) assigned to the corresponding region cblk with respect to the encoding target image (see step S1403).

This process may be performed by any method and is similar to that performed in the above step S1401 although the target region and the viewpoints for the relevant start and end points are different between both steps. In addition, a method other than that employed in step S1401 may be employed.

Additionally, to simplify the process, “dv_src_{blk}=−dv_{blk} ” may be employed.

Furthermore, adaptive selection between a simplified method and an ordinary method may be performed. For example, the accuracy (or reliability) of dv_{blk} may be estimated, and whether or not the simplified method is selected may be determined according to the estimated result.

Next, the motion information generation unit 106 determines temporary motion information “tmv” from reference viewpoint motion information which is stored in association with the corresponding region cblk (see step S1404).

If there are a plurality of motion information items for the corresponding region, one of them is selected according to any criterion. For example, motion information stored for the center of the corresponding region may be selected, or motion information assigned to a widest area in the corresponding region may be selected.

When motion information in which different motions are determined in each of reference frame lists is utilized (as employed in H.264 or the like), motion information obtained by selecting a motion for each reference frame list may be determined.

After the temporary motion information tmv is obtained, the motion information generation unit 106 obtains a reference region “rblk” from the reference viewpoint, where the correspondence to this region is obtained by the relevant temporary motion information (see step S1405). More specifically, rblk is obtained by adding the temporary motion information tmv to the corresponding region cblk. Here, the reference region rblk is a region on a frame at a different time and is indicated by the temporary motion information.

After the reference region rblk is obtained, the disparity information generation unit 105 determines a disparity vector dv_dst_{blk} (corresponding to the past disparity information of the present invention) assigned to the reference region rblk with respect to the encoding target image (see step S1406).

This process may be performed by any method and is similar to that performed in the above step S1401 or S1403 although the target region and the viewpoints for the relevant start and end points are different between the relevant steps. A method other than that employed in step S1401 or S1403 may be employed.

Finally, the motion information generation unit 106 utilizes dv_src_{blk}, dv_dst_{blk}, and tmv to obtain motion information my for the encoding target region blk by the following formula (1) (see step S1407):

mv=tmv+dv_dst_{blk}−dv_src_{blk} (1)

In the above explanation, the motion information my is directly determined to be the motion information for the encoding target region blk. However, a time interval may be set in advance, and scaling of the motion information my may be performed according to the predetermined time interval and a time interval at which the motion information my is generated so that motion information obtained by replacing the original time interval with the predetermined interval is determined to be the target motion information.

In this case, motion information items generated for different regions have the same time interval, and thus the image referred to in the motion-compensated prediction is unified and the accessed memory space can be restricted.

When the accessed memory space is restricted, the processing speed can be improved by means of “cache hit” (i.e., target data exists in a cache area and can be read out).

Additionally, there is reference viewpoint motion information for every corresponding region cblk in the above explanation. However, the reference viewpoint motion information may not exist when, for example, intra prediction is applied to the corresponding region cblk. In such a case, the operation may be terminated with a result that no motion information is obtained, or motion information may be determined by a predetermined method.

When no reference viewpoint motion information is present for the corresponding region cblk, the temporary motion information may be determined by the following methods: (i) temporary motion information having a predetermined time interval and a zero vector may be employed, or (ii) temporary motion information generated for the encoding target region processed immediately before is stored and this stored temporary motion information may be employed.

The stored temporary motion information may be reset to a zero vector at regular intervals.

When no reference viewpoint motion information is present for the corresponding region cblk, no temporary motion information may be set and motion information my for the encoding target region blk may be directly generated by a predetermined method. For example, motion information having a predetermined time interval and a zero vector may be set.

Additionally, in the above explanation, one motion information is generated for the entire encoding target region blk (this information may include a plurality of motion vectors and reference frames for each reference frame or prediction direction). However, the encoding target region may be divided into smaller regions and motion information may be generated for each smaller region.

In this case, the operation shown in FIG. 3 may be repeated for each smaller region, or only part of the operation (e.g., steps S1402 to S1407) in FIG. 3 may be repeated for each smaller region.

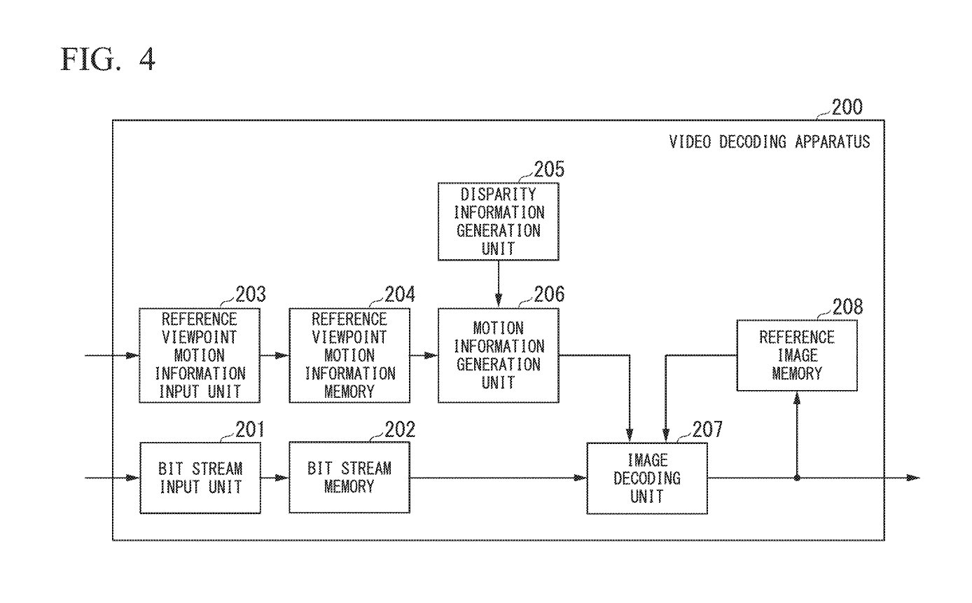

Below, a video decoding apparatus of the present embodiment will be explained. FIG. 4 is a block diagram that shows the structure of the video decoding apparatus in the present embodiment.

As shown in FIG. 4, the video decoding apparatus 200 includes a bit stream input unit 201, a bit stream memory 202, a reference viewpoint motion information input unit 203, a reference viewpoint motion information memory 204, a disparity information generation unit 205, a motion information generation unit 206, an image decoding unit 207, and a reference image memory 208.

The bit stream input unit 201 inputs a bit stream of a video, as a decoding target, into the video decoding apparatus 200. Below, the input one frame (of the video) as the decoding target is called a “decoding target image”. Here, one frame of the video from the viewpoint B is input. In addition, the viewpoint (here, the viewpoint B) from which the decoding target image is obtained is called a “decoding target viewpoint”.

The bit stream memory 202 stores the input bit stream for the decoding target image.

The reference viewpoint motion information input unit 203 inputs motion information (e.g., motion vector) for a video from the reference viewpoint (here, the viewpoint A) into the video decoding apparatus 200. Below, the motion information input here is called “reference viewpoint motion information”, and a frame (at the same time as that of the decoding target image) to which the reference viewpoint motion information is assigned is called a “reference viewpoint image”.

The reference viewpoint motion information memory 204 stores the input reference viewpoint motion information.

If the bit stream or reference viewpoint motion information is stored outside the video decoding apparatus 200 and the bit stream input unit 201 or the reference viewpoint motion information input unit 203 inputs the required bit stream or reference viewpoint motion information into the video decoding apparatus 200 at appropriate timing, it is unnecessary to provide the bit stream memory 202 or the reference viewpoint motion information memory 204.

The disparity information generation unit 205 generates disparity information (disparity vector) between the decoding target image and the reference viewpoint image.

The motion information generation unit 206 generates motion information of the decoding target image by using the reference viewpoint motion information and the disparity information.

The image decoding unit 207 decodes the decoding target image from the bit stream by using the generated motion information and outputs the decoded result.

The reference image memory 208 stores the obtained decoding target image so as to be used in future decoding.

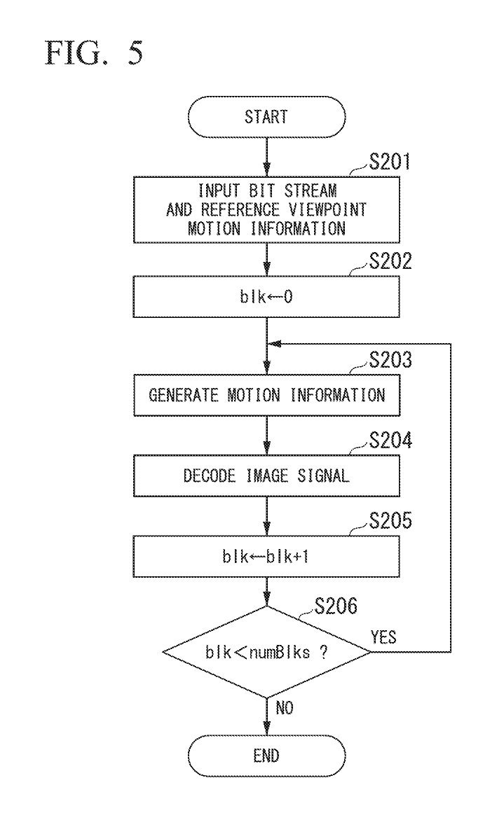

Next, the operation of the video decoding apparatus 200 shown in FIG. 4 will be explained with reference to FIG. 5. FIG. 5 is a flowchart showing the operation of the video decoding apparatus 200 shown in FIG. 4.

First, the bit stream input unit 201 inputs a bit stream as a result of the encoding of the decoding target image into the video decoding apparatus 200 and stores the input bit stream in the bit stream memory 202. The reference viewpoint motion information input unit 203 inputs reference viewpoint motion information into the video decoding apparatus 200 and stores the input information in the reference viewpoint motion information memory 204 (see step S201).

Here, the reference viewpoint motion information input in step S201 is identical to that used in the encoding apparatus. This is because generation of encoding noise (e.g., drift) can be suppressed by using the completely same information as information which can be obtained in the video encoding apparatus. However, if generation of such encoding noise is acceptable, information which differs from that used in the encoding apparatus may be input.

The reference viewpoint motion information may be motion information used when the reference viewpoint image was decoded or may be motion information encoded separately for the reference viewpoint. In addition, a video from the reference viewpoint may be decoded and motion information obtained by performing estimation from the decoded video may be employed.

After the input of the bit stream and the reference viewpoint motion information is completed, the decoding target image is divided into regions having a predetermined size, and for each divided region, the video signal of the decoding target image is decoded from the bit stream (see steps S202 to S206).

More specifically, given “blk” for a decoding target region index and “numBlks” for the total number of decoding target regions in one frame, blk is initialized to be 0 (see step S202), and then the following process (from step S203 to step S204) is repeated while adding 1 to blk each time (see step S205) until blk reaches numBlks (see step S206).

In ordinary decoding, the decoding target image is divided into processing unit blocks called “macroblocks” each being formed as 16×16 pixels. However, it may be divided into blocks having another block size if the condition is the same as that in the encoding apparatus. In addition, the divided regions may have individual sizes.

In the process repeated for each decoding target region, first, the motion information generation unit 206 generates motion information “mv” for the decoding target region blk (see step S203). This process is identical to that performed in step S103 although there is only a difference between “encoding” and “decoding”.

After the motion information my for the decoding target region blk is obtained, the image decoding unit 207 decodes, from the bit stream, the image signal (i.e., pixel values) of the decoding target image of the decoding target region blk by using the motion information my and also referring to an image stored in the reference image memory 208 (see step S204). The obtained decoding target image is stored in the reference image memory 208 and also functions as a signal output from the video decoding apparatus 200.

For the decoding of the decoding target image, a method corresponding to that used in the encoding apparatus is employed. For example, when generally known encoding such as MPEG-2 or H.264/AVC is employed, the relevant encoded data is sequentially subjected to entropy decoding, inverse binarization, inverse quantization, and frequency inverse transformation such as IDCT. Then the predicted image is added to the obtained two-dimensional signal, and clipping within the value range of the pixels is finally performed so as to decode the relevant image signal.

In the decoding, the generated motion information my may be used in any manner. For example, the video signal of the decoding target region blk may be decoded for a predicted image which is a motion compensation predicted image by using the motion information my.

In another method, a correction vector “cmv” for the above “mv” is decoded from the bit stream, and motion information is obtained by correcting my by cmv. A motion compensation predicted image generated according to the obtained motion information is used as the predicted image to decode the image signal of the decoding target region blk. In this case, it is necessary to provide information separately, which indicates whether or not a bit stream for cmv is included in the bit stream input into the present video decoding apparatus.

In the above-explained operation, one frame is encoded and then decoded. However, a video can be encoded by repeating the operation for a plurality of frames. Here, the relevant operation need not be applied to all frames of the video.

In addition, although the above explanation employs an operation of encoding or decoding the entire image, the operation may be applied to only part of the image. In this case, whether the operation is to be applied or not may be determined and a flag that indicates a result of the determination may be encoded or decoded, or the result may be designated by using an arbitrary device. For example, whether the operation is to be applied or not may be represented as one of the modes that indicate methods of generating a predicted image for each region.

In addition, although the structures and operations of the video encoding apparatus and the video decoding apparatus are explained in the above explanation, the video encoding method and the video decoding method of the present invention can be implemented by operations corresponding to the operations of the individual units in the video encoding apparatus and the video decoding apparatus.

As described above, when motion information for a viewpoint of a processing target is generated, no existing motion information is directly reused, but motion information for a viewpoint other than that for a processing target of encoding or decoding is used to consider motion information in a three-dimensional space, which corresponds to the existing motion information, and to apply transformation to the motion information for the viewpoint other than that for the processing target so as to utilize the transformed motion information. Accordingly, even when the inter-camera correlation for motion information between frames from different viewpoints is low, highly accurate prediction for the motion information is implemented, and thus multiview videos can be encoded with less amount of code.

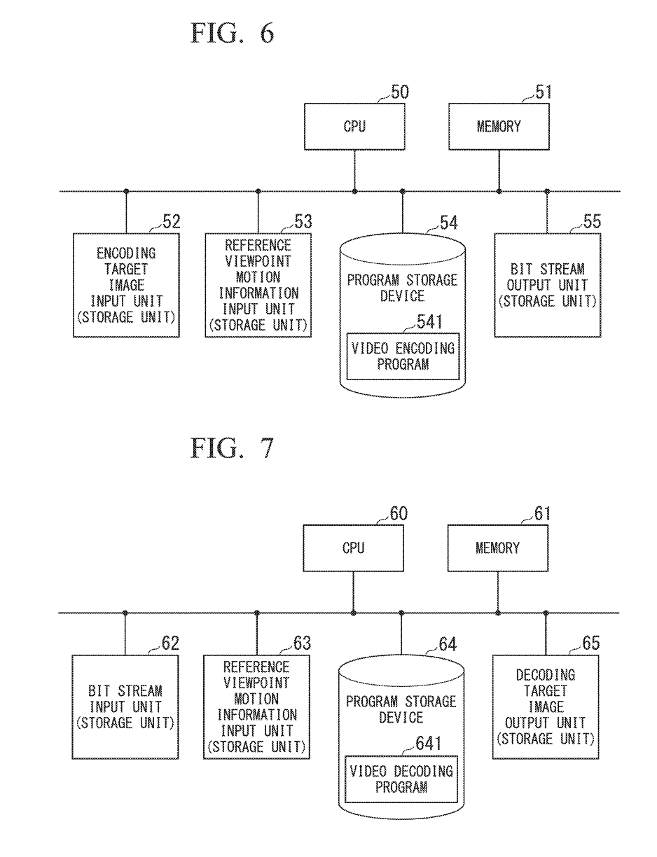

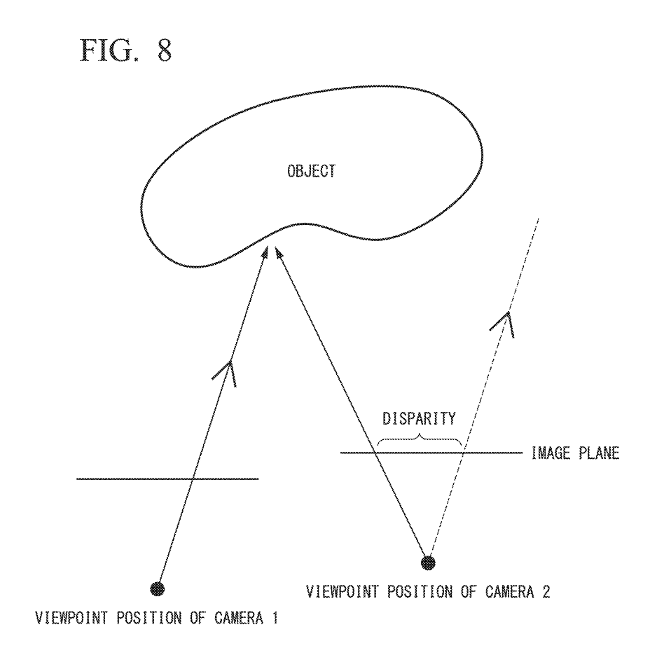

FIG. 6 is a block diagram that shows a hardware configuration of the above-described video encoding apparatus 100 formed using a computer and a software program.

In the system of FIG. 6, the following elements are connected via a bus:
(i) a CPU 50 that executes the relevant program;
(ii) a memory 51 (e.g RAM) that stores the program and data accessed by the CPU 50;
(iii) an encoding target image input unit 52 that makes a video signal of an encoding target from a camera or the like input into the video encoding apparatus and may be a storage unit (e.g., disk device) which stores the video signal;
(iv) a reference viewpoint motion information input unit 53 that makes motion information for a reference viewpoint input from a memory or the like into the video encoding apparatus and may be a storage unit (e.g., disk device) which stores the motion information;
(v) a program storage device 54 that stores a video encoding program 541 which is a software program for making the CPU 50 execute the video encoding operation; and
(vi) a bit stream output unit 55 that outputs a bit stream, which is generated by the CPU 50 which executes the video encoding program 541 loaded on the memory 51, via a network or the like, where the output unit 55 may be a storage unit (e.g., disk device) which stores the bit stream.

FIG. 7 is a block diagram that shows a hardware configuration of the above-described video decoding apparatus 200 formed using a computer and a software program.

In the system of FIG. 7, the following elements are connected via a bus:
(i) a CPU 60 that executes the relevant program;
(ii) a memory 61 (e.g., RAM) that stores the program and data accessed by the CPU 60;
(iii) a bit stream input unit 62 that makes a bit stream encoded by the video encoding apparatus according to the present method into the video decoding apparatus and may be a storage unit (e.g., disk device) which stores the bit stream;
(iv) a reference viewpoint motion information input unit 63 that makes motion information for a reference viewpoint input from a memory or the like into the video decoding apparatus and may be a storage unit (e.g., disk device) which stores the motion information;
(v) a program storage device 64 that stores an image decoding program 641 which is a software program for making the CPU 60 execute the video decoding operation; and
(vi) a decoding target image output unit 65 that outputs a decoding target image, which is obtained by the CPU 60 which executes the video decoding program 641 loaded on the memory 61 so as to decode the bit stream, to a reproduction apparatus or the like, where the output unit 65 may be a storage unit (e.g., disk device) which stores the image signal. [0081] p The video encoding apparatus 100 and the video decoding apparatus 200 in the above embodiment may be implemented by utilizing a computer. In this case, a program for executing the relevant functions may be stored in a computer-readable storage medium, and the program stored in the storage medium may be loaded and executed on a computer system, so as to implement the relevant apparatus.

Here, the computer system has hardware resources which may include an OS and peripheral devices.

The above computer-readable storage medium is a storage device, for example, a portable medium such as a flexible disk, a magneto optical disk, a ROM, or a CD-ROM, or a memory device such as a hard disk built in a computer system.

The computer-readable storage medium may also include a device for temporarily storing the program, for example, (i) a device for dynamically storing the program for a short time, such as a communication line used when transmitting the program via a network (e.g., the Internet) or a communication line (e.g., a telephone line), or (ii) a volatile memory in a computer system which functions as a server or client in such a transmission.

In addition, the program may execute a part of the above-explained functions. The program may also be a “differential” program so that the above-described functions can be executed by a combination of the differential program and an existing program which has already been stored in the relevant computer system. Furthermore, the program may be implemented by utilizing a hardware devise such as a PLD (programmable logic device) or an FPGA (field programmable gate array).

While the embodiments of the present invention have been described and shown above, it should be understood that these are exemplary embodiments of the invention and are not to be considered as limiting. Additions, omissions, substitutions, and other modifications can be made without departing from the technical concept and scope of the present invention.

### INDUSTRIAL APPLICABILITY

The present invention can be applied to a purpose which essentially requires the following: when encoding (or decoding) is performed by estimating or predicting motion information of an encoding (or decoding) target image by using motion information for an image photographed from a viewpoint other than that from which the encoding (or decoding) target image was photographed, even if the inter-camera correlation for motion information between images from the different viewpoints is low, a high level of encoding efficiency can be implemented.

### REFERENCE SYMBOLS

100 video encoding apparatus 100
101 encoding target image input unit 101
102 encoding target image memory 102
103 reference viewpoint motion information input unit 103
104 reference viewpoint motion information memory 104
105 disparity information generation unit 105
106 motion information generation unit 106
107 image encoding unit 107
108 image decoding unit 108
109 reference image memory 109.
200 video decoding apparatus 200
201 bit stream input unit
202 bit stream memory
203 reference viewpoint motion information input unit
204 reference viewpoint motion information memory
205 disparity information generation unit
206 motion information generation unit
207 image decoding unit
208 reference image memory

1. A video encoding apparatus that encodes one frame of multiview videos from different viewpoints, where each of encoding target regions obtained by dividing an encoding target image is encoded while reference viewpoint motion information, which is motion information for a reference viewpoint image from a reference viewpoint other than a viewpoint of the encoding target image, is used to perform prediction between different viewpoints, the apparatus comprising:
an encoding target region disparity information determination device that determines, for the encoding target region, encoding target region disparity information which indicates a corresponding region on the reference viewpoint image;
a temporary motion information determination device that determines, from the reference viewpoint motion information, temporary motion information for the corresponding region on the reference viewpoint image, which is indicated by the encoding target region disparity information;
a past disparity information determination device that determines past disparity information which is disparity information assigned to a region from the reference viewpoint, which is indicated by the temporary motion information, with respect to the viewpoint of the encoding target image; and
a motion information generation device that generates motion information for the encoding target region by performing transformation of the temporary motion information by using the encoding target region disparity information and the past disparity information.

2. The video encoding apparatus in accordance with claim 1, wherein:
the motion information generation device generates the motion information for the encoding target region by:
restoring motion information of an object in a three-dimensional space from the temporary motion information by using the encoding target region disparity information and the past disparity information; and
projecting the restored motion information onto the encoding target image.

3. The video encoding apparatus in accordance with claim 1, further comprising:
a reference target region dividing device that divides the corresponding region on the reference viewpoint image into smaller regions,
wherein the temporary motion information determination device determines the temporary motion information for each smaller region; and
the motion information generation device generates the motion information for each smaller region.

4. The video encoding apparatus in accordance with claim 3, wherein:
the past disparity information determination device determines the past disparity information for each smaller region.

5. The video encoding apparatus in accordance with claim 1, wherein:
the encoding target region disparity information determination device determines the encoding target region disparity information from a depth map for an object imaged in the multiview videos.

6. The video encoding apparatus in accordance with claim 1, wherein:
the past disparity information determination device determines the past disparity information from a depth map for an object imaged in the multiview videos.

7. The video encoding apparatus in accordance with claim 1, further comprising:
a present disparity information determination device that determines present disparity information which is disparity information assigned to the corresponding region on the reference viewpoint image with respect to the viewpoint of the encoding target image,
wherein the motion information generation device performs the transformation of the temporary motion information by using the present disparity information and the past disparity information.

8. The video encoding apparatus in accordance with claim 7, wherein:
the present disparity information determination device determines the present disparity information from a depth map for an object imaged in the multiview videos.

9. The video encoding apparatus in accordance with claim 1, wherein:
the motion information generation device generates the motion information for the encoding target region by using the sum of the encoding target region disparity information, the past disparity information, and the temporary motion information.

10. A video decoding apparatus that decodes a decoding target image from encoded data of multiview videos from different viewpoints, where each of decoding target regions obtained by dividing a decoding target image is decoded while reference viewpoint motion information, which is motion information for a reference viewpoint image from a reference viewpoint other than a viewpoint of the decoding target image, is used to perform prediction between different viewpoints, the apparatus comprising:
a decoding target region disparity information determination device that determines, for the decoding target region, decoding target region disparity information which indicates a corresponding region on the reference viewpoint image;
a temporary motion information determination device that determines, from the reference viewpoint motion information, temporary motion information for the corresponding region on the reference viewpoint image, which is indicated by the decoding target region disparity information;
a past disparity information determination device that determines past disparity information which is disparity information assigned to a region from the reference viewpoint, which is indicated by the temporary motion information, with respect to the viewpoint of the decoding target image; and
a motion information generation device that generates motion information for the decoding target region by performing transformation of the temporary motion information by using the decoding target region disparity information and the past disparity information.

11. The video decoding apparatus in accordance with claim 10, wherein:
the motion information generation device generates the motion information for the decoding target region by:
restoring motion information of an object in a three-dimensional space from the temporary motion information by using the decoding target region disparity information and the past disparity information; and
projecting the restored motion information onto the decoding target image.

12. The video decoding apparatus in accordance with claim 10, further comprising:
a reference target region dividing device that divides the corresponding region on the reference viewpoint image into smaller regions,
wherein the temporary motion information determination device determines the temporary motion information for each smaller region; and
the motion information generation device generates the motion information for each smaller region.

13. The video decoding apparatus in accordance with claim 12, wherein:
the past disparity information determination device determines the past disparity information for each smaller region.

14. The video decoding apparatus in accordance with claim 10, wherein:
the decoding target region disparity information determination device determines the decoding target region disparity information from a depth map for an object imaged in the multiview videos.

15. The video decoding apparatus in accordance with claim 10, wherein:
the past disparity information determination device determines the past disparity information from a depth map for an object imaged in the multiview videos.

16. The video decoding apparatus in accordance with claim 10, further comprising:
a present disparity information determination device that determines present disparity information which is disparity information assigned to the corresponding region on the reference viewpoint image with respect to the viewpoint of the decoding target image,
wherein the motion information generation device performs the transformation of the temporary motion information by using the present disparity information and the past disparity information.

17. The video decoding apparatus in accordance with claim 16, wherein:
the present disparity information determination device determines the present disparity information from a depth map for an object imaged in the multiview videos.

18. The video decoding apparatus in accordance with claim 10, wherein:
the motion information generation device generates the motion information for the decoding target region by using the sum of the decoding target region disparity information, the past disparity information, and the temporary motion information.

19. A video encoding method that encodes one frame of multiview videos from different viewpoints, where each of encoding target regions obtained by dividing an encoding target image is encoded while reference viewpoint motion information, which is motion information for a reference viewpoint image from a reference viewpoint other than a viewpoint of the encoding target image, is used to perform prediction between different viewpoints, the method comprising:
an encoding target region disparity information determination step that determines, for the encoding target region, encoding target region disparity information which indicates a corresponding region on the reference viewpoint image;
a temporary motion information determination step that determines, from the reference viewpoint motion information, temporary motion information for the corresponding region on the reference viewpoint image, which is indicated by the encoding target region disparity information;
a past disparity information determination step that determines past disparity information which is disparity information assigned to a region from the reference viewpoint, which is indicated by the temporary motion information, with respect to the viewpoint of the encoding target image; and
a motion information generation step that generates motion information for the encoding target region by performing transformation of the temporary motion information by using the encoding target region disparity information and the past disparity information.

20. A video decoding method that decodes a decoding target image from encoded data of multiview videos from different viewpoints, where each of decoding target regions obtained by dividing a decoding target image is decoded while reference viewpoint motion information, which is motion information for a reference viewpoint image from a reference viewpoint other than a viewpoint of the decoding target image, is used to perform prediction between different viewpoints, the method comprising:
a decoding target region disparity information determination step that determines, for the decoding target region, decoding target region disparity information which indicates a corresponding region on the reference viewpoint image;
a temporary motion information determination step that determines, from the reference viewpoint motion information, temporary motion information for the corresponding region on the reference viewpoint image, which is indicated by the decoding target region disparity information;
a past disparity information determination step that determines past disparity information which is disparity information assigned to a region from the reference viewpoint, which is indicated by the temporary motion information, with respect to the viewpoint of the decoding target image; and
a motion information generation step that generates motion information for the decoding target region by performing transformation of the temporary motion information by using the decoding target region disparity information and the past disparity information.
